(19) United States
(12) Patent Application Publication
(10) Pub. No.: US 2021/0247920 A1
(43) Pub. Date: Aug. 12, 2021

(54) APPLICATION MANAGEMENT IN FLASH STORAGE SYSTEMS

(71) Applicant: QUALCOMM Incorporated, San Diego, CA (US)

(72) Inventors: Sujith KOTTILA VEETTIL, Hyderabad (IN); Sudan Vilas LANDGE, Hyderabad (IN); Srinivasulu Reddy BEERELLI, Hyderabad (IN); Hemanth ACHANTA, West Godavari District (IN)

(21) Appl. No.: 16/783,650

(22) Filed: Feb. 6, 2020

(51) Int. Cl. G06F 3/06; G06F 9/54; G06F 12/02

(52) U.S. Cl. CPC G06F 3/0644; G06F 3/064; G06F 3/0604; G06F 9/541; G06F 12/0246; G06F 3/0679

(57) ABSTRACT

In some aspects, the present disclosure provides a method for managing applications in flash memory devices. In one example, an application manager is configured to manage data stored in an application partition of a flash memory device. The application manager may be configured to receive a request from an application processor to read a first application data stored on the application partition of the flash memory device partitioned into the application partition and a second partition, and manage one or more applications stored on the first partition according to a physical block mapping of the one or more applications.

### BACKGROUND

### Field of the Disclosure

The teachings of the present disclosure relate generally to memory operations, and more particularly, to techniques for managing applications in a flash storage device.

### Description of the Related Art

Flash memory (e.g., non-volatile computer storage medium) is a type of memory that can store and hold data without a constant source of power. In contrast, data stored in volatile memory can be erased if power to the memory is lost. Flash memory is a type of non-volatile memory that has become popular in many applications. For example, flash memories are used in many communication devices, automobiles, cameras, etc. In some cases, flash memories are required to support a relatively large number of applications in a single device. Such applications may include software that supports operation of a camera, a display, location services, user applications, etc.

However, the data stored on some flash memories may be prone to corruption due to shortcomings of the flash memories. For example, some NAND devices are prone to data corruption in sudden power loss scenarios. Thus, if a device suddenly loses power (e.g., a battery of the device runs out of power), there is a significant risk that the data stored in the flash memory will be corrupted.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects provide a method for managing applications stored in a flash memory. The method may include receiving, by an application manager, a request from an application processor to read first application data stored on a first partition of a flash memory device partitioned into the first partition and a second partition, the application manager configured to manage one or more applications stored on the first partition according to a physical block mapping of the one or more applications, the second partition managed by a file system configured to manage data stored on the second partition according to a logical block mapping of the data. In some examples, the method includes fetching, by the application manager, a table of contents stored on a first block of the first partition, the table of contents comprising the physical block mapping of the one or more applications including a mapping between an address of a first physical block of the first partition and the first application stored on the first physical block. In some examples, the method includes reading, by the application manager, the table of contents to determine the address of the first physical block. In some examples, the method includes reading, by the application manager, the first application data from the first physical block. In some examples, the method includes communicating, by the application manager, the read first application data to the application processor.

Certain aspects provide an apparatus for managing applications stored in a flash memory. In some examples, the apparatus includes a memory and a processor communicatively coupled to the memory, the processor comprising an application manager. In some examples, the application manager is configured to receive a request from an application processor to read first application data stored on a first partition of a flash memory device partitioned into the first partition and a second partition, the application manager configured to manage one or more applications stored on the first partition according to a physical block mapping of the one or more applications, the second partition managed by a file system configured to manage data stored on the second partition according to a logical block mapping of the data. In some examples, the application manager is configured to fetch a table of contents stored on a first block of the first partition, the table of contents comprising the physical block mapping of the one or more applications including a mapping between an address of a first physical block of the first partition and the first application stored on the first physical block. In some examples, the application manager is configured to read the table of contents to determine the address of the first physical block. In some examples, the application manager is configured to read the first application data from the first physical block. In some examples, the application manager is configured to communicate the read first application data to the application processor.

Certain aspects provide for a non-transitory computer-readable storage medium that stores instructions that when executed by a processor of an apparatus cause the apparatus to perform a method for managing applications stored in a flash memory. In some examples, the method includes receiving, by an application manager, a request from an application processor to read first application data stored on a first partition of a flash memory device partitioned into the first partition and a second partition, the application manager configured to manage one or more applications stored on the first partition according to a physical block mapping of the one or more applications, the second partition managed by a file system configured to manage data stored on the second partition according to a logical block mapping of the data. In some examples, the method includes fetching, by the application manager, a table of contents stored on a first block of the first partition, the table of contents comprising the physical block mapping of the one or more applications including a mapping between an address of a first physical block of the first partition and the first application stored on the first physical block. In some examples, the method includes reading, by the application manager, the table of contents to determine the address of the first physical block. In some examples, the method includes reading, by the application manager, the first application data from the first physical block. In some examples, the method includes communicating, by the application manager, the read first application data to the application processor.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram illustrating an exemplary system-on-chip (SoC) integrated circuit in accordance with certain aspects of the present disclosure.

FIG. 2 is block diagram illustrating an exemplary memory system that may be used by the SoC of FIG. 1, in accordance with certain aspects of the present disclosure.

FIGS. 3A and 3B are block diagrams conceptually illustrating example sets of physical blocks in an application partition of a flash memory in accordance with certain aspects of the present disclosure.

FIG. 4 is a flow chart illustrating example operations managing applications in flash storage systems in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with various other embodiments discussed herein.

The term “system on chip” (SoC) is used herein to refer to an integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects of the present disclosure. Such memory technologies/types may include phase change memory (PRAM), dynamic random-access memory (DRAM), static random-access memory (SRAM), non-volatile random-access memory (NVRAM), flash memory (e.g., embedded multimedia card (eMMC) flash, flash erasable programmable read only memory (FEPROM), NAND flash, etc.), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory.

Non-volatile memory devices, such as flash memory devices, may be provided in a NOR-type configuration or a NAND-type configuration and can be electrically rewritten and formed with high integration density. NAND-type nonvolatile semiconductor memory devices include a plurality of NAND cell units. Each NAND cell unit is configured by serially connecting a plurality of memory transistors in a column direction between a source and a drain. Selection gate (SG) transistors may be connected to at each end of the series-connected memory transistor circuit.

Each of the above-mentioned memory technologies include, for example, elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims to a particular memory system or technology unless specifically recited in the claim language. Mobile computing device architectures have grown in complexity, and now commonly include multiple processor cores, SoCs, co-processors, functional modules including dedicated processors (e.g., communication modem chips, global positioning system (GPS) processors, display processors, etc.), complex memory systems, intricate electrical interconnections (e.g., buses and/or fabrics), and numerous other resources that execute complex and power intensive software applications (e.g., video streaming applications, etc.).

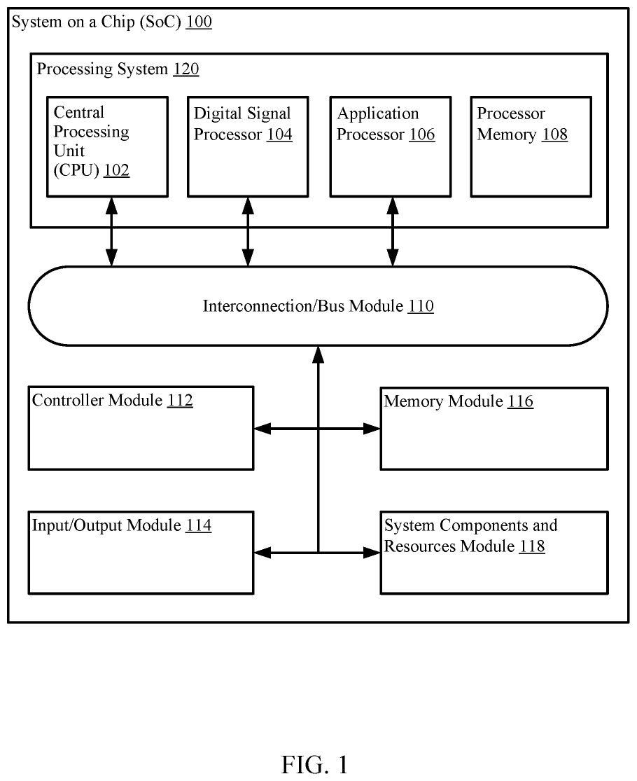

FIG. 1 is a block diagram illustrating an exemplary system-on-chip (SoC) 100 suitable for implementing various aspects of the present disclosure. The SoC 100 includes a processing system 120 that includes a plurality of heterogeneous processors such as a central processing unit (CPU) 102, a digital signal processor 104, an application processor 106, and a processor memory 108. The processing system 120 may include one or more cores, and each processor/core may perform operations independent of the other processors/cores. The processors 102, 104, and 106 may be organized in close proximity to one another (e.g., on a single substrate, die, integrated chip, etc.) so that they may operate at a much higher frequency/clock-rate than would be possible if the signals were to travel off-chip. The proximity of the cores may also allow for the sharing of on-chip memory and resources (e.g., voltage rail), as well as for more coordinated cooperation between cores.

The processing system 120 is interconnected with one or more controller module(s) 112, input/output (I/O) module(s) 114, memory module(s) 116, and system component and resources module(s) 118 via a bus module 110 which may include an array of reconfigurable logic gates and/or implement bus architecture (e.g., CoreConnect, advanced microcontroller bus architecture (AMBA), etc.). Bus module 110 communications may be provided by advanced interconnects, such as high performance networks on chip (NoCs). The interconnection/bus module 110 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc. In some cases, the bus module 110 may implement an arbitration scheme to prevent multiple master components from attempting to drive the bus simultaneously.

The controller module 112 may be a specialized hardware module configured to manage the flow of data to and from the memory module 116, the processor memory 108, or a memory device located off-chip (e.g., a flash memory device). In some examples, the memory module may include a UFS host device configured to receive various memory commands from multiple masters, and address and communicate the memory commands to a memory device. The multiple masters may include processors 102, 104, and 106, and/or multiple applications running on one or more of the processors 102, 104, and 106. The controller module 112 may comprise one or more processors configured to perform operations disclosed herein. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The I/O module 114 is configured for communicating with resources external to the SoC. For example, the I/O module 114 includes an input/output interface (e.g., a bus architecture or interconnect) or a hardware design for performing specific functions (e.g., a memory, a wireless device, and a digital signal processor). In some examples, the I/O module includes circuitry to interface with peripheral devices, such as a memory device located off-chip.

The memory module 116 is a computer-readable storage medium implemented in the SoC 100. The memory module 116 may provide non-volatile storage, such as flash memory, for one or more of the processing system 120, controller module 112, I/O module 114, and/or the system components and resources module 118. The memory module 116 may include a cache memory to provide temporary storage of information to enhance processing speed of the SoC 100. In some examples, the memory module 116 may be implemented as a universal flash storage (UFS) integrated into the SoC 100, or an external UFS card.

The SoC 100 may include a system components and resources module 118 for managing sensor data, analog-to-digital conversions, wireless data transmissions, and for performing other specialized operations (e.g., supporting interoperability between different devices). System components and resources module 118 may also include components such as voltage regulators, oscillators, phase-locked loops, peripheral bridges, data controllers, system controllers, access ports, timers, and other similar components used to support the processors and software clients running on the computing device. The system components and resources 118 may also include circuitry for interfacing with peripheral devices, such as cameras, electronic displays, wireless communication devices, external memory chips, etc.

In certain aspects, the data stored on some flash memories may be prone to corruption due to shortcomings of the flash memories. For example, some NAND devices are prone to data corruption in sudden power loss scenarios. Thus, if a device suddenly loses power (e.g., a battery of the device runs out of power), there is a significant risk that the data stored in the flash memory will be corrupted. While backing up data stored on the NAND devices frequently can help resolve these issues, there are often scenarios where the data stored in the flash memory is too large. Thus, there is a need to effectively manage files and applications stored on a flash memory device, such that redundant data is reduced or eliminated to save memory resources, and corruption of application management files is reduced or eliminated.

### Example of Application Management in Flash Storage

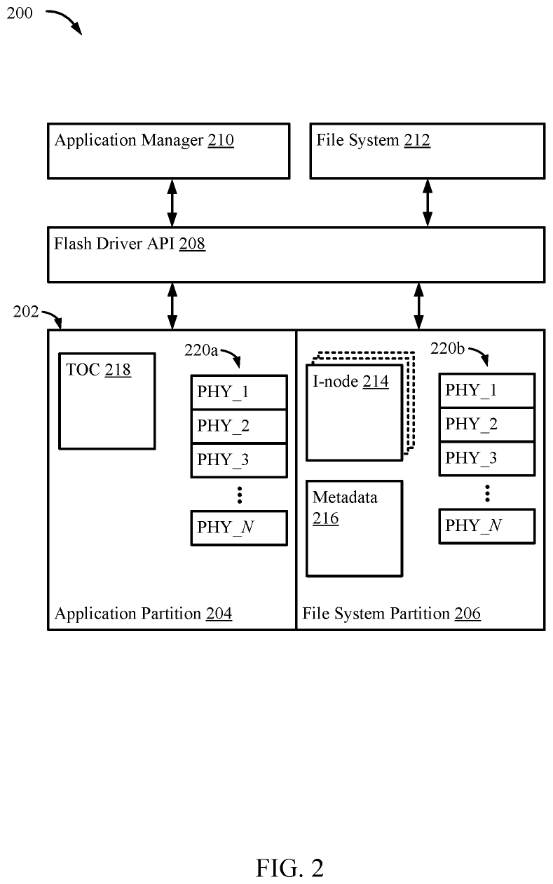

FIG. 2 is block diagram illustrating an exemplary memory system 200 that may be used by an SoC (e.g., SoC 100 of FIG. 1) in accordance with certain aspects of the present disclosure. The memory system 200 includes a flash memory 202 that is partitioned into at least two separate subdivisions. A first subdivision is an application partition 204, and a second subdivision is a file system partition 206.

A flash driver application program interface (API) 208 (e.g., implemented by I/O module 114 and/or controller module 112 of FIG. 1) may provide control of I/O commands and communications between the flash memory 202 and an application manager 210, a file system 212, or any other systems. For example, application manager 210 and file system 212 may be processes executed by one or more processing units, such as one or more processors of processing system 120. For example, the flash driver API 208 may be used by the application manager 210, the file system 212, and other such systems to implement read, write, erase, and other I/O commands, and manage communications between the flash memory 202 and other devices (e.g., processing system 120 of FIG. 1). As used herein, the flash driver API 208 relates to a software component configured to manage and expose the physical layout and functional aspects of the flash memory 202 to the application manager 210, file system 212, etc. The flash driver API 208 may be executed by one or more processing units, such as one or more processors of processing system 120.

The use of multiple partitions of the flash memory 202 provides the application manager 210 and the file system 212 with the ability to simultaneously access the flash memory 202. In some embodiments, each partition is implemented as a physically separate device of the flash memory 202. For example, each of the application manager 210 and file system 212 may correspond to a particular partition within the flash memory 202. Accordingly, while the application manager 210 utilizes the flash driver API 208 to access the application partition 204, file system 212 can simultaneously utilize the flash driver API 208 to access the file system partition 206.

As background, data (e.g., files, applications, etc.) stored on flash memory 202 has a name, a payload (e.g., the information corresponding to the files, applications, etc. being stored), and attributes (e.g., the last time it was modified, its size, etc.). In general, file systems, such as file system 212, are part of an operating system configured to manage the data stored on the flash memory 202. To keep track of the data, file systems utilize directories that contain directory entries which include names, attributes, and addresses of the files and applications stored on a flash memory. File systems typically split such data into two separate structures: one or more i-nodes (e.g., i-nodes 214) containing logical block or logical page addresses corresponding to the physical blocks (e.g., physical blocks 220b) where the files and applications are stored, and metadata (e.g., metadata 216) containing file names, attributes, and locations of the i-nodes. Thus, in order for the file system to determine a physical block address that corresponds to a logical block address, the file system must rely on, (i) one or more i-nodes to translate, or map, the logical block address to the physical block address, and (ii) a metadata file to determine the locations of the i-nodes.

Accordingly, in relation to FIG. 2, the file system 212 may be configured to utilize the metadata 216 stored on the file system partition 206 to locate one or more i-nodes 214 (also stored on the file system partition 206) to determine a physical block address that corresponds to a logical block address. For example, if the file system 212 receives an I/O command, the file system 212 may utilize the flash driver API 208 to read the metadata 216 to locate and read an i-node 214 in order to translate, or map, a logical block address associated with the I/O command to the corresponding physical block address. As such, data structures such as the metadata 216 and the i-nodes 214 may be vulnerable to corruption in the event of a sudden power loss, which would render the data stored in the physical blocks 220b unreadable by the file system 212.

Thus, in certain aspects, application manager 210 may function in a similar manner as file system 212, but without the i-nodes 214 and metadata 216. For example, like the file system 212, the application manager 210 receive I/O commands from applications and/or processors (e.g., application processor 106 of FIG. 1), and processes those commands with the flash memory 202. However, in contrast to file system 212, application manager 210 may be configured to process the I/O commands and track the data stored in the flash memory 202 by utilizing a table of contents 218. The table of contents 218 may be stored on the application partition 204, and contain directory entries which include names and attributes of the stored files and applications, as well as addresses to the physical blocks 220a/220b of the flash memory 202 that store the corresponding files and applications. As such, the application manager 210 may utilize the flash driver API 208 to read the table of contents 218. Unlike the metadata 216 and i-nodes 214 required by the file system 212, the table of contents 218 provides the application manager 210 with a direct path to the physical blocks that contain data corresponding to an I/O command. Accordingly, the table of contents 218 is less vulnerable to corruption than the multiple data structures associated with the metadata 216 and i-nodes 214.

In certain aspects, one or more of the application manager 210 and the file system 212 may be configured to use only certain partitions of the flash memory 202. For example, the file system 212 may be limited to using any partition except for the application partition 204. Accordingly, memory resources of the application partition 204 are preserved for other data because data structures such as the i-nodes 214 and the metadata 216 are not required to be on the application partition 204 to support the file system 212.

In certain aspects, the table of contents 218 may be stored only on one partition (e.g., the application partition 204), and thus, may be relevant only to the one partition. However, in other aspects, the table of contents 218 may be stored on the application partition 204 and contain information regarding applications and files stored on the application partition 204, as well as other partitions (e.g., file system partition 206), and include the physical blocks (e.g., physical blocks 220a and 220b) on which those files and applications are stored. In such an example, the application manager 210 can manage applications and files stored in multiple partitions using a single table of contents 218.

### Example Operation of the Application Manager

In some embodiments, the application manager 210 may receive a memory I/O command from an application running on a processor (e.g., application processor 106 of FIG. 1) or another processor or subsystem on an SoC (e.g., SoC 100 of FIG. 1). For example, the I/O command may include a request to read data of a first application stored on a first partition (e.g., application partition 204 of FIG. 2) of a flash memory device (e.g., flash memory 202 of FIG. 2). In some examples, the flash memory 202 may be partitioned into multiple memory partitions, including the application partition 204, and a second partition (e.g., file system partition 206 of FIG. 2). The application partition 204 may include a first set of physical blocks 220a of the flash memory 202, and the file system partition 206 may include a second set of physical blocks 220b.

In certain aspects, the application manager 210 is configured to manage the data of one or more applications and/or files stored on the application partition 204 according to a physical block mapping of the data. In contrast, a file system (e.g., file system 212 of FIG. 2) is configured to manage data stored on the file system partition 206 according to a logical block mapping of the data. For example, the application manager 210 may utilize a table of contents 218 to manage the data stored on the application partition 204, while the file system 212 may utilize i-nodes 214 and metadata 216 to manage data stored on the file system partition 206. In some examples, the application manager 210 may search a plurality of physical blocks 220a of the application partition 204 for a first physical block identified by a magic number indicating that the first physical block contains the table of contents 218. As such, the table of contents 218 may be stored on any physical block in the application partition 204.

Once the application manager 210 receives the I/O command, the application manager 210 may fetch the table of contents 218 from the application partition 204. In some examples, the table of contents 218 may be stored on a first block of the application partition 204. In such an example, the application manager 210 may utilize the flash driver API 208 to fetch, or read, the table of contents 218. As noted previously, the table of contents 218 may include mapping between physical blocks 220a of the application partition 204 and the one or more applications and/or files stored on the blocks. For example, the table of contents 218 may be an index, mapping applications by name to one or more physical blocks that each application is stored on. In one example, the table of contents 218 may include a mapping between an address of a second physical block of the application partition 204 and a name of the first application stored on the second physical block. In some examples, the table of contents 218 include a list of the names of applications stored on the application partition 204, wherein the list includes information for each block corresponding to the applications (e.g., block addresses for each application, validity of one or more blocks associated with the applications, etc.). In some embodiments, the table of contents 218 may include a number indicative of the number of applications stored on the application partition 204.

Once the table of contents 218 has been fetched, the application manager 210 may read the table of contents 218 to determine the address of one or more physical blocks 220a that store data of the first application. Upon determining the one or more physical blocks that store the first application data, the application manager 210 may utilize the flash driver API 208 to read the first application data from the one or more physical blocks, and communicate the first application data to the application processor 106 in response to the received I/O command.

Accordingly, the application manager 210 can perform memory I/O commands (e.g., read, write, erase, etc.) directly with the physical blocks via the table of contents instead of going through the multiple data structures and the logical mapping between logical addresses and physical addresses required by file system 212. This saves time and resources that are otherwise required by the file system 212, which has to determine a proper i-node 214 and translate the logical blocks to physical blocks. Moreover, the application manager 210 eliminates the potential for corruption of an i-node 214 or metadata 216 data structure which would prevent the file system 212 from accessing the applications stored on the file system partition 206.

In some embodiments, the application manager 210 may be configured to store an application to the application partition 204. For example, the application manager 210 may receive the application to be stored from a processor or retrieve the application from another memory device. Initially, the application manager 210 may determine a number of physical blocks required to store the application. For example, the application manager may receive information about the application to be stored, including the size of the application.

Next, the application manager 210 may determine one or more addresses of one or more unused physical blocks in the application partition. In one example, the application manager 210 may read the table of contents 218 to determine which of the physical blocks 220a are unused and the addresses of the unused physical blocks. If the application manager 210 determines that there are a sufficient amount of unused blocks that the application can be written to, the application manager 210 may select which physical blocks will store the application, then proceed to write the application to the selected unused blocks. In some examples, the application manager 210 will select blocks that are contiguous, such that the application is written to a contiguous series of physical blocks. For example, the application manager 210 may determine that PHY_2 and PHY_3 of the physical blocks 220a are unused and may write the application to those blocks. In some examples throughout the disclosure, an unused block may also be referred to as a “free block.”

Next, the application manager 210 may update the table of contents 218 to include an index mapping the application to the addresses of the one or more physical blocks that were selected to store the application. Accordingly, the table of contents 218 is updated to reflect the addition of the application stored in the application partition 204.

In some embodiments, the application manager 210 may be configured to update an application already stored in the application partition 204. For example, the application manager 210 may receive a request from a processor to update an application stored on PHY_1 through PHY_3 of the physical blocks 220a. Initially, the application manager 210 may update the table of contents 218 to indicate that the table of contents 218 is invalid as to information related to PHY_1 through PHY_3.

Next, the application manager 210 may erase PHY_1 through PHY_3 to remove the previously stored contents. Then the application manager 210 may write the updated application data to any available, unused physical blocks. For example, the application manager 210 may write the updated application data to the recently erased PHY_1 through PHY_3, or the application manager 210 may determine to write the updated application data to fewer or more physical blocks, depending on the size of the updated application data.

In some embodiments, the application manager 210 may be configured to delete an application already stored in the application partition 204. For example, the application manager 210 may receive a request from a processor to remove application data stored on PHY 1 through PHY_3 of the physical blocks 220a. Initially, the application manager may mark as invalid entries of the table of contents 218 corresponding the application to be removed. Once the table of contents 218 has been updated, the application manager 210 may erase the application data stored on PHY_1 through PHY_3, then update the table of contents 218 again to indicate that PHY_1 through PHY_3 are unused.

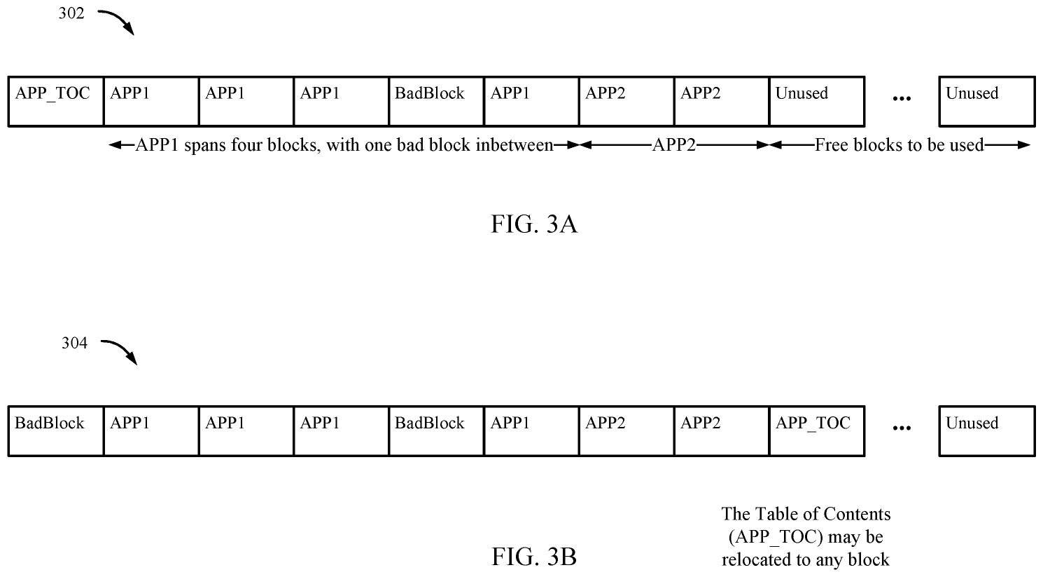

In some embodiments, the application manager 210 may be configured to update the table of contents to indicate which block(s) in the physical blocks 220a are no longer functioning correctly (e.g., “BadBlock” of FIG. 3 described below). For example, the application manager 210 may perform a disk scrubbing process on the application partition 204. In some examples, the disk scrubbing process may relate to functions for detecting and correcting errors that occur in the data write process, as well as randomly over time thereafter. Such functions may include data integrity checks configured to determine which physical blocks contain defective application data.

If the application manager 210 determines that a physical block is no longer functioning correctly (e.g., through scrubbing of the application partition 204, or any other suitable data integrity check or method of detecting a bad physical block), the application manager may mark the addresses of the defective block(s) in the table of contents 218 to indicate which block(s) in the physical blocks 220a are no longer functioning correctly. Thus, when storing or updating an application in the application partition, the application manager 210 may only search the blocks that are not indicated as a “BadBlock.”

In some examples, the application manager 210 is configured to update the table of contents 218 to indicate which physical blocks of the application partition 204 are free. As such, the application manager 210 may be configured to maintain the table of contents 218 such that the table of contents 218 includes a list of the one or more physical blocks that are free or unused.

In certain aspects, the application manager 210 may include a scheduling function configured to periodically trigger a disk scrubbing process to determine whether there are any bad blocks in the application partition 204, and/or to correct any blocks with invalid information. In some examples, prior to a scrub of the application partition 204, the application manager 210 may capture a state of the application partition 204 and store the state in the file system partition 206 or in another digital storage location. Accordingly, if there is a power loss situation during the scrubbing process, the application partition 204 may recover using the stored state information. In some examples, the scrubbing process may include shifting the data stored on the physical blocks 220a up or down by one or more blocks.

Once the state of the application partition 204 is stored, the application manager may shift the application data stored on the application partition 204 by at least one physical block. Accordingly, the application manager 210 may perform a disk scrubbing operation configured to refresh the data of the application partition 204. This reduces the possibility of corrupt data in the physical blocks 220a.

FIGS. 3A and 3B are block diagrams conceptually illustrating example sets of physical blocks (302 and 304) in a partition (e.g., application partition 204 of FIG. 2) of a flash memory (e.g., flash memory 202 of FIG. 2). As shown, each physical block is labeled according to its state (e.g., “BadBlock,” which corresponds to a physical block that is degraded or malfunctioning, or “Unused,” which corresponds to a physical block that does not contain data or contains obsolete data that can be written over) or according to the data stored on the block (e.g., “APP_TOC,” which corresponds to a table of contents (e.g., table of contents 218 of FIG. 2), “APP1,” which corresponds to a first application, and “APP2,” which corresponds to a second application). Such labeling of the physical blocks (302 and 304) may be reflected in the table of contents 218 shown in FIG. 2.

In certain aspects, FIGS. 3A and 3B provide a conceptual illustration of the information stored on the table of contents 218. For example, the table of contents 218 may indicate the state or data stored on a block, as well as the address of the block (e.g., the location of the block among the physical blocks 220a). In some examples, the table of contents 218 provides an array of application information mapped to corresponding physical blocks. For example, the table of contents 218 may identify a number of applications stored on the physical blocks 220a, a number of unused blocks in the physical blocks 220a, and the application information for each physical block. The application information for each physical block may include the application name, the data on the block, and the validity of the block. It is appreciated the information in the table of contents may include additional information, including any additional information suitable for identifying the state and contents of the physical blocks 220a.

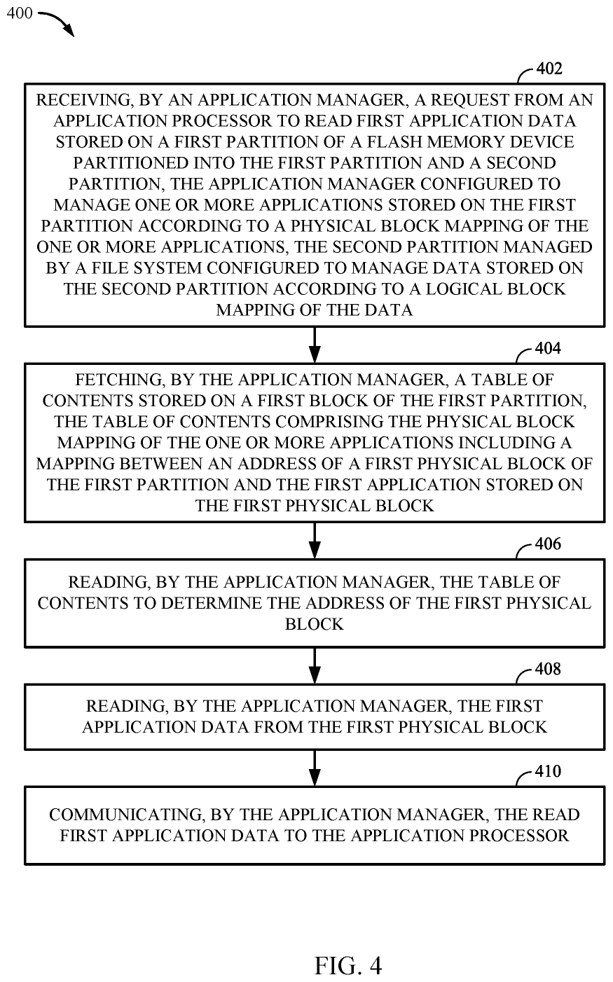

FIG. 4 is a flow chart illustrating example operations 400 for application management in flash storage systems. The operations 400 may be performed, for example, by a memory (e.g., such as the memory module 116 of the SoC 100 in FIG. 1) and a memory controller (e.g., such as the controller module 112 of FIG. 1). Operations 400 may be implemented as software components that are executed and run on one or more processors (e.g., processing system 120 of FIG. 1). In certain aspects, the transmission and/or reception of data by various hardware components may be implemented via a bus interface (e.g., bus module 110 of FIG. 1).

In this example, the operations 400 start at a first step 402 by receiving, by an application manager, a request from an application processor to read first application data stored on a first partition of a flash memory device partitioned into the first partition and a second partition, the application manager configured to manage one or more applications stored on the first partition according to a physical block mapping of the one or more applications, the second partition managed by a file system configured to manage data stored on the second partition according to a logical block mapping of the data.

The operations 400 may proceed to step 404, by fetching, by the application manager, a table of contents stored on a first block of the first partition, the table of contents comprising the physical block mapping of the one or more applications including a mapping between an address of a first physical block of the first partition and the first application stored on the first physical block.

The operations 400 may proceed to step 406 by reading, by the application manager, the table of contents to determine the address of the first physical block.

The operations 400 may proceed to step 408 by reading, by the application manager, the first application data from the first physical block.

The operations 400 may proceed to step 410 by communicating, by the application manager, the read first application data to the application processor.

In certain aspects, fetching the table of contents comprises searching, by the application manager, a plurality of physical blocks of the first partition for a physical block identified by a magic number, wherein the physical block identified by the magic number contains the table of contents.

In certain aspects, the operations 400 include reading, by the application manager, the first application data from the first physical block address via a flash driver application programming interface (API).

In certain aspects, the operations 400 include determining, by the application manager, a number of physical blocks required to store a second application in the first partition, determining, by the application manager, an address of a second physical block in the first partition, the second physical block having no data stored thereon, writing, by the application manager, the second application to the second physical block, and updating, by the application manager, the table of contents to include an index mapping the second application to the address of the second physical block.

In certain aspects, the operations 400 include receiving, by the application manager, a request from the application processor to update the first application data stored on the first partition, marking as invalid an entry of the table of contents corresponding to the first application, erasing one or more physical blocks containing the first application, writing updated application data to one or more physical blocks that are free, and updating the table of contents to include an index mapping the updated application to the one or more physical blocks.

In certain aspects, updating the table of contents further comprises maintaining a list of the one or more physical blocks that are free.

In certain aspects, the operations 400 include receiving, by the application manager, a request from the application processor to remove the first application data stored on the first partition, marking as invalid an entry of the table of contents corresponding to the first application, and erasing one or more physical blocks containing the first application.

In certain aspects, the operations 400 include performing, by the application manager, an integrity check of application data stored on the first partition, the integrity check configured to determine physical blocks that contain defective application data, and writing, by the application manager, an address of the one or more physical blocks that are determined to contain defective application data to the table of contents.

In certain aspects, the table of contents comprises a mapping of physical block addresses to a plurality of applications stored on the first partition.

In certain aspects, the operations 400 include performing, by the application manager, a scrubbing process on the first partition, the scrubbing process configured to detect an error in one or more physical blocks of the first partition.

In certain aspects, the operations 400 include performing the scrubbing process periodically and according to a scrubbing timer set by the application manager.

In certain aspects, the scrubbing process comprises storing the application data stored on the first partition in another partition to prevent loss of the application data during the scrubbing process, and shifting the application data stored on the first partition by at least one physical block.

In certain aspects, the file system is configured to manage data stored on the second partition via a plurality of i-nodes, and wherein the application manager is configured to manage data stored on the first partition via a physical block mapping of the one or more applications instead of via the plurality of i-nodes.

### Additional Considerations

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for” or simply as a “block” illustrated in a figure.

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise. The software may be stored on non-transitory computer-readable medium included in the processing system.

Accordingly, in one or more exemplary embodiments, the functions described may be implemented in hardware, software, or combinations thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A method for managing applications stored in a flash memory, comprising:
receiving, by an application manager, a request from an application processor to read first application data stored on a first partition of a flash memory device partitioned into the first partition and a second partition, the application manager configured to manage one or more applications stored on the first partition according to a physical block mapping of the one or more applications, the second partition managed by a file system configured to manage data stored on the second partition according to a logical block mapping of the data;
fetching, by the application manager, a table of contents stored on a first block of the first partition, the table of contents comprising the physical block mapping of the one or more applications including a mapping between an address of a first physical block of the first partition and the first application stored on the first physical block;
reading, by the application manager, the table of contents to determine the address of the first physical block;
reading, by the application manager, the first application data from the first physical block; and
communicating, by the application manager, the read first application data to the application processor.

2. The method of claim 1, wherein fetching the table of contents comprises searching, by the application manager, a plurality of physical blocks of the first partition for a physical block identified by a magic number, wherein the physical block identified by the magic number contains the table of contents.

3. The method of claim 1, further comprising reading, by the application manager, the first application data from the first physical block address via a flash driver application programming interface (API).

4. The method of claim 1, further comprising:
determining, by the application manager, a number of physical blocks required to store a second application in the first partition;
determining, by the application manager, an address of a second physical block in the first partition, the second physical block having no data stored thereon;
writing, by the application manager, the second application to the second physical block; and
updating, by the application manager, the table of contents to include an index mapping the second application to the address of the second physical block.

5. The method of claim 1, further comprising:
receiving, by the application manager, a request from the application processor to update the first application data stored on the first partition;
marking as invalid an entry of the table of contents corresponding to the first application;
erasing one or more physical blocks containing the first application;
writing updated application data to one or more physical blocks that are free; and
updating the table of contents to include an index mapping the updated application to the one or more physical blocks.

6. The method of claim 5, wherein updating the table of contents further comprises maintaining a list of the one or more physical blocks that are free.

7. The method of claim 1, further comprising:
receiving, by the application manager, a request from the application processor to remove the first application data stored on the first partition;
marking as invalid an entry of the table of contents corresponding to the first application; and
erasing one or more physical blocks containing the first application.

8. The method of claim 1, further comprising:
performing, by the application manager, an integrity check of application data stored on the first partition, the integrity check configured to determine physical blocks that contain defective application data; and
writing, by the application manager, an address of the one or more physical blocks that are determined to contain defective application data to the table of contents.

9. The method of claim 1, wherein the table of contents comprises a mapping of physical block addresses to a plurality of applications stored on the first partition.

10. The method of claim 1, further comprising performing, by the application manager, a scrubbing process on the first partition, the scrubbing process configured to detect an error in one or more physical blocks of the first partition.

11. The method of claim 10, further comprising performing the scrubbing process periodically and according to a scrubbing timer set by the application manager.

12. The method of claim 10, wherein the scrubbing process comprises:
storing the application data stored on the first partition in another partition to prevent loss of the application data during the scrubbing process; and
shifting the application data stored on the first partition by at least one physical block.

13. The method of claim 1, wherein the file system is configured to manage data stored on the second partition via a plurality of i-nodes, and wherein the application manager is configured to manage data stored on the first partition via a physical block mapping of the one or more applications instead of via the plurality of i-nodes.

14. An apparatus for managing applications stored in a flash memory, comprising:
a memory; and
a processor communicatively coupled to the memory, the processor configured to execute an application manager configured to:
receive a request from an application processor to read first application data stored on a first partition of a flash memory device partitioned into the first partition and a second partition, the application manager configured to manage one or more applications stored on the first partition according to a physical block mapping of the one or more applications, the second partition managed by a file system configured to manage data stored on the second partition according to a logical block mapping of the data;
fetch a table of contents stored on a first block of the first partition, the table of contents comprising the physical block mapping of the one or more applications including a mapping between an address of a first physical block of the first partition and the first application stored on the first physical block;
read the table of contents to determine the address of the first physical block;
read the first application data from the first physical block; and
communicate the read first application data to the application processor.

15. The apparatus of claim 14, wherein the application manager, being configured to fetch the table of contents, is further configured to search a plurality of physical blocks of the first partition for a physical block identified by a magic number, wherein the physical block identified by the magic number contains the table of contents.

16. The apparatus of claim 14, wherein the application manager is further configured to read the first application data from the first physical block address via a flash driver application programming interface (API).

17. The apparatus of claim 14, wherein the application manager is further configured to:
determine a number of physical blocks required to store a second application in the first partition;
determine an address of a second physical block in the first partition, the second physical block having no data stored thereon;
write the second application to the second physical block; and
update the table of contents to include an index mapping the second application to the address of the second physical block.

18. The apparatus of claim 14, wherein the application manager is further configured to:
receive a request from the application processor to update the first application data stored on the first partition;
mark as invalid an entry of the table of contents corresponding to the first application;
erase one or more physical blocks containing the first application;
write updated application data to one or more physical blocks that are free; and
update the table of contents to include an index mapping the updated application to the one or more physical blocks.

19. The apparatus of claim 18, wherein the application manager, being configured to update the table of contents, is further configured to maintain a list of the one or more physical blocks that are free.

20. A non-transitory computer-readable storage medium that stores instructions that when executed by a processor of an apparatus cause the apparatus to perform a method for managing applications stored in a flash memory, the method comprising:
receiving, by an application manager, a request from an application processor to read first application data stored on a first partition of a flash memory device partitioned into the first partition and a second partition, the application manager configured to manage one or more applications stored on the first partition according to a physical block mapping of the one or more applications, the second partition managed by a file system configured to manage data stored on the second partition according to a logical block mapping of the data;
fetching, by the application manager, a table of contents stored on a first block of the first partition, the table of contents comprising the physical block mapping of the one or more applications including a mapping between an address of a first physical block of the first partition and the first application stored on the first physical block;
reading, by the application manager, the table of contents to determine the address of the first physical block;
reading, by the application manager, the first application data from the first physical block; and
communicating, by the application manager, the read first application data to the application processor.
